(19) United States
(12) Patent Application Publication
(10) Pub. No.: US 2026/0208760 A1
(43) Pub. Date: Jul. 23, 2026

(54) GENERATING OR UPDATING A DIGITAL REPRESENTATION OF A TRAJECTORY, SELF-LOCALIZATION OF AN EGO-VEHICLE AND GUIDING AN EGO-VEHICLE AT LEAST IN PART AUTOMATICALLY

(71) Applicant: CONNAUGHT ELECTRONICS Ltd., Tuam (IE)

(72) Inventors: Rekha Ramachandra, Tuam (IE); Catherine Enright, Tuam (IE); Ana Robleda, Porrino Pontevedra (ES); German Feijoo, Porrino Pontevedra (ES)

(73) Assignee: CONNAUGHT ELECTRONICS Ltd., Tuam, County Galway (IE)

(21) Appl. No.: 19/136,189

(22) PCT Filed: Nov. 30, 2023
(86) PCT No.: PCT/EP2023/083645

§ 371 Date: Jun. 5, 2025

(30) Foreign Application Priority Data
Dec. 5, 2022 (DE) 10 2022 132 204.1

(51) Int. Cl. B60W 60/00; B60W 30/06; G06T 7/246; G06T 7/73

(52) U.S. Cl. CPC B60W 60/001; B60W 30/06; G06T 7/246; G06T 7/73; B60W 2420/403; B60W 2520/00; B60W 2556/50; G06T 2207/30241; G06T 2207/30252

(57) ABSTRACT

Described is a method for generating or updating a digital representation of a trajectory in a predefined spatial region. For each time instance while driving a capturing vehicle along the trajectory, a camera image of an environment of the capturing vehicle is captured by a camera of the capturing vehicle. A feature descriptor of the respective camera image is determined. A two-dimensional pose of the capturing vehicle in a coordinate system of the digital representation is determined depending on the camera image, and an altitude of the capturing vehicle is determined. A respective dataset of the digital representation, which includes the respective feature descriptor, the respective pose of the capturing vehicle, and the respective altitude of the capturing vehicle is generated or updated.

The present invention is directed to a method for generating or updating a digital representation of a trajectory in a predefined spatial region, to a method for self-localization of an ego-vehicle and to a method for guiding an ego-vehicle at least in part automatically. The invention is further directed to a corresponding system for generating or updating a digital representation of a trajectory in a predefined spatial region, a system for self-localization of an ego-vehicle and to an electronic vehicle guidance system as well as to computer program products.

For autonomous driving functions or semi-autonomous driving functions, for example autonomous or semi-autonomous parking, of a vehicle, it is necessary that the systems of the vehicle are able to determine the vehicle's position in its environment. Global navigation satellite systems, GNSS, may be used in principle for this purpose. However, they may have limitations regarding accuracy, in particular when the vehicle is located in a building such as a parking facility, for example a parking garage or an underground parking garage.

It is also well-known to use methods for simultaneous localization and mapping, SLAM, to build a local map and/or trajectory of or in the environment of the vehicle based on sensor data from one or more sensor systems of the vehicle. In case cameras are used as sensors, such methods are denoted by visual simultaneous localization and mapping, VSLAM.

VSLAM is mainly a solution based on feature points used to build a local map or trajectory. In case the scenario is an underground parking facility or a multi-level parking facility, the self-localization is potentially not reliable considering that each floor of the multi-level parking facility or underground parking facility may visually appear very similar. In such a scenario, the features obtained from one floor may potentially match features obtained from other parking floors. This makes it difficult for VSLAM to determine the position of the vehicle with respect to the digital map.

Document CN 113947636 A is directed to a laser SLAM positioning system and method based on deep learning. Features of ground points, planes and edges are extracted from a point cloud. This this end, a random sample consensus, RANSAC, algorithm is used. Laser odometry is used to optimize the poses.

Other SLAM or VSLAM algorithms are filter-based algorithms, in particular are based on Kalman filtering or extended Kalman filtering.

Document WO 2019/073038 A1 describes a method for automatically parking a vehicle in a parking slot. The vehicle is manually driven into the parking slot in a training step and thereafter automatically driven into the parking slot in a replay step. For the automatic driving of the vehicle, information of features in the environment of the vehicle corresponding to the driven trajectory is detected, feature descriptors of the detected features of the environment are matched with feature descriptors stored in a digital map, and the vehicle is re-localized against the trajectory stored in the digital map in order to navigate the vehicle along the stored trajectory into the parking slot. Therein, a feature descriptor relates to an algorithmic representation of how a respective feature looks. For example, a feature descriptor may relate to a part of a two-dimensional visual image of the environment.

It is an objective of the present invention to improve the reliability for self-localization and/or at least in part automatic guidance of a vehicle in a spatial region based on camera images.

This objective is achieved by the subject-matter of the independent claim. Further implementations and preferred embodiments are subject-matter of the dependent claims.

The invention is based on the idea to track the altitude of a capturing vehicle explicitly when generating or updating a digital representation of a trajectory, which may be used for self-localization or at least in part automatic guidance of a vehicle along a prerecorded trajectory.

According to an aspect of the invention, a method for generating or updating a digital representation of a trajectory in a predefined spatial region is provided. A capturing vehicle, which is in particular a motor vehicle, is driven along a trajectory in the spatial region and for each of a plurality of time instances while driving the capturing vehicle along the trajectory, a respective camera image of an environment of the capturing vehicle is captured by a camera of the capturing vehicle. For each of the plurality of time instances, at least one feature descriptor of the respective camera image is determined depending on the respective camera image, in particular by at least one computing unit of the capturing vehicle. For each of the plurality of time instances, a two-dimensional pose of the capturing vehicle in a coordinate system, in particular a two-dimensional coordinate system, of the digital representation is determined depending on the respective camera image, in particular by the at least one computing unit. For each of the plurality of time instances, an altitude of the capturing vehicle at the respective time instance is determined. For each of the plurality of time instances, a respective dataset of the digital representation, which comprises the respective at least one feature descriptor, the respective pose of the capturing vehicle and the respective altitude of the capturing vehicle, is generated or updated and, in particular, stored.

The spatial region is, in particular a three-dimensional spatial region and contains, for example, a multi-level facility with two or more floors on which the capturing vehicle can drive. The two or more floors can be above ground and/or underground. The spatial region may, for example, comprise a multi-level underground and/or above-ground parking facility.

The digital representation comprises or consists of all of the datasets generated or updated for the plurality of time instances. The digital representation and the respective generated or updated datasets are in particular stored on a storage device of the capturing vehicle or a storage device external to the capturing vehicle, for example, of a server computer or cloud computer.

The camera is mounted to the capturing vehicle such that that the field of view of the camera covers a corresponding portion of the outer environment of the capturing vehicle. The camera can, for example, be a front camera of the capturing vehicle.

A feature descriptor can be understood as an algorithmic or computer-readable expression, which describes a corresponding feature in the respective camera image. Such features may be extracted and determined from the camera images in a known way, for example by using object detection algorithms, corner detection algorithms, edge detection algorithms and so forth. A corner, an edge or another type of object or structure may correspond to a feature in this case. A feature descriptor may, for example, contain or depend on the pixel intensity values or the pixel intensity gradient values in the camera image corresponding to the given feature. However, there may also be other ways to characterize certain features in camera images by means of suitable feature descriptors, and these may be used in the present invention as well. In particular, features and feature descriptors as commonly used in VLSAM may be used for the invention as well.

The features or feature descriptors, respectively, have for example the purpose of recognizing a certain part of the environment at a later time. If the capturing vehicle or another vehicle drives in the predefined spatial region and captures a further camera image, it can be searched for certain features in the further camera image and tried to match them with the previously stored features by using their feature descriptors. If a match is found, this information can be used for re-localizing and/or guiding the capturing vehicle or further vehicle accordingly.

The coordinate system of the digital representation may be understood as a map coordinate system of a digital map in which the trajectory and optionally further information, for example, regarding the environment or the spatial region, is stored. The two-dimensional pose corresponds to a two-dimensional position in a corresponding coordinate plane and a corresponding orientation angle in this plane with respect to a reference direction and a predefined origin of the coordinate system. The altitude of the capturing vehicle may be understood as a height of the capturing vehicle above or below a predefined reference plane, for example a ground plane.

The plurality of time instances and the corresponding datasets, which may also be denoted as key-frames, define the trajectory. There may, however, be additional images be captured in between the plurality of time instances, which do not correspond to such key-frames. It is not necessary that the trajectory is already predefined when the method is carried out. In this case, the datasets are initially generated in the course of the method, in particular using VSLAM. However, the digital representation may also exist before the method is carried out, and the datasets of the trajectory and the trajectory itself may therefore be predefined. In this case, the datasets are updated in such that the two-dimensional pose is in particular refined or its accuracy is improved when updating the respective dataset, in particular using VSLAM.

The two-dimensional pose is determined based on the respective camera image captured at the corresponding time instance. However, also camera images captured before that particularly time instance may be used to determine the two-dimensional pose, for example, based on visual odometry.

A computing unit may in particular be understood as a data processing device, which comprises processing circuitry. The computing unit can therefore in particular process data to perform computing operations. This may also include operations to perform indexed accesses to a data structure, for example a look-up table, LUT.

In particular, the computing unit may include one or more computers, one or more microcontrollers, and/or one or more integrated circuits, for example, one or more application-specific integrated circuits, ASIC, one or more field-programmable gate arrays, FPGA, and/or one or more systems on a chip, SoC. The computing unit may also include one or more processors, for example one or more microprocessors, one or more central processing units, CPU, one or more graphics processing units, GPU, and/or one or more signal processors, in particular one or more digital signal processors, DSP. The computing unit may also include a physical or a virtual cluster of computers or other of said units.

In various embodiments, the computing unit includes one or more hardware and/or software interfaces and/or one or more memory units.

A memory unit may be implemented as a volatile data memory, for example a dynamic random access memory, DRAM, or a static random access memory, SRAM, or as a non-volatile data memory, for example a read-only memory, ROM, a programmable read-only memory, PROM, an erasable programmable read-only memory, EPROM, an electrically erasable programmable read-only memory, EEPROM, a flash memory or flash EEPROM, a ferroelectric random access memory, FRAM, a magnetoresistive random access memory, MRAM, or a phase-change random access memory, PCRAM.

According to the invention, apart from the two-dimensional pose and the at least one feature descriptor, the respective altitude of the capturing vehicle is determined and stored for each key-frame. In this way, the key-frames can be used for re-localization or guiding of the capturing vehicle or a further vehicle at a later time with a higher reliability since the altitude can be used as an additional information in addition to the feature descriptors for identifying the correct key-frame. This is particularly beneficial in cases where different key-frames have the same or approximately the same or similar feature descriptors, in particular when the underlying camera images depict portions of the environment or spatial region, respectively, which appear visually similar. For example, in a multi-level parking facility, the environment may look similar on different levels or floors, on which the vehicle can drive. Therefore, the at least one feature descriptor for different key-frames may be similar as well. Consequently, the correct key-frame may be identified by the aid of the altitude or in other words, the available key-frames or trajectories may be filtered with respect to the stored altitudes to improve the reliability of the re-localization or guidance.

In the following, the vehicle using the generated or updated digital representation of the trajectory at a later time, is denoted as ego-vehicle. The ego-vehicle may be identical to the capturing vehicle but may also be a different vehicle which has received the generated or updated digital representation for re-localization purposes and/or for automatic or partially automatic guidance of the vehicle.

The altitude can be determined in different ways which are per se known. For example, odometry, in particular visual odometry, may be used to determine the altitude. Alternatively, a differential global navigation satellite system, dGNSS, also denoted as differential global positioning system, dGPS, may be used. Consequently, for example, the at least one computing unit of the capturing vehicle may determine the altitude depending on the camera images captured at the plurality of the time instances and/or further camera images captured by the camera or a further camera of the vehicle. In case of dGNSS, the at least one computing unit may determine the altitude depending on respective position and correction information obtained by a dGNSS receiver system of the vehicle, in particular from navigational satellites and a base station installed in or close to the predefined spatial region, which has an accurately known position in the coordinate system.

According to several implementations, motion data of the capturing vehicle is determined while the capturing vehicle is driven along the trajectory, and the two-dimensional pose is determined depending on the motion data using odometry.

The motion data may, for example, include a number of wheel rotations of respective wheels of the capturing vehicle while driving along the trajectory and/or steering angles of the capturing vehicle while driving along the trajectory and may consequently be determined by means of respective wheel rotation sensors and/or steering angle sensors etcetera.

In this case, the two-dimensional pose of the capturing vehicle is determined based on the respective camera image or camera images and the motion data. Consequently, the two-dimensional pose can be determined with improved accuracy.

According to several implementations, an algorithm for VSLAM is used for determining the two-dimensional pose of the capturing vehicle depending on the camera image and in respective implementations if applicable depending on the motion data. For example, a filter based VSLAM algorithm may be used.

Consequently, the two-dimensional pose may be determined with high accuracy and also when the trajectory is followed for the first time by the capturing vehicle or the capturing vehicle is driving in the predefined spatial region for the first time.

According to several implementations, the altitude is determined using visual odometry based on the respective camera images captured for the plurality of time instances and/or based on further camera images captured by the camera or a further camera of the capturing vehicle, while the capturing vehicle is driven along the trajectory.

In particular, all camera images available at the time of determining the altitude or a fraction of all available camera images may be used to compute the altitude.

Visual odometry is able to determine the altitude with a high accuracy, in particular with an improved accuracy with respect to other methods, for example mechanical odometry. Furthermore, visual odometry does not depend on the availability of respective radio signals or a good reception of such signals in contrast to, for example, GNSS-based approaches. This makes visual odometry particularly suitable in scenarios within buildings such as multi-level parking facilities.

According to several alternative implementations, the altitude is determined using a dGNSS.

By means of dGNSS, a higher accuracy of the altitude may be achieve compared approaches using regular GNSS. For dGNSS, a satellite receiver of the capturing vehicle may receive corresponding positioning signals from two or more navigational satellites and correction signals from a base station which is arranged in the environment of the capturing vehicle, in particular in the spatial region. The base station also receives the position signals from the navigational satellites. Since its position is, in contrast to the position of the capturing vehicle, predetermined and known with high accuracy, the base station or another computing unit can determine the correction signals from a deviation of the base station's position computed from the position signal received from the navigational satellites and the predetermined position of the base station.

According to several implementations, the spatial region contains a multi-level parking facility, for example a multi-level parking garage or an underground parking garage with multiple floors or parking facility with underground and above-ground floors.

In such cases, the invention is particularly beneficial since here it may happen frequently that the feature descriptor of different key-frames are approximately the same due to the similar visual appearance of the environment and different floors of the parking facility.

According to a further aspect of the invention, a method for self-localization of an ego-vehicle is provided. Therein, a digital representation of a trajectory is generated or updated by using a method for generating or updating a digital representation of a trajectory according to the invention. A further camera image of an environment of the ego-vehicle is captured by a camera of the ego-vehicle, in particular while the ego-vehicle is located in the predefined spatial region. At least one further feature descriptor of the further camera image is determined, in particular by at least one computing unit of the ego-vehicle, and an altitude of the ego-vehicle is determined, in particular by the at least one computing unit of the ego-vehicle. One of the datasets of the digital representation is selected, in particular by the at least one computing unit of the ego-vehicle, depending on the determined altitude of the ego-vehicle and the at least one further feature descriptor. A two-dimensional pose of the ego-vehicle in the coordinate system of the digital representation is determined from the selected dataset.

In particular, the pose of the ego-vehicle determined from the selected dataset corresponds to the two-dimensional pose of the capturing vehicle contained by the corresponding selected dataset.

Since the selected dataset is selected based on the determined altitude and the at least one further feature descriptor, the reliability of the determined pose of the ego-vehicle is improved as described above.

According to several implementations of the method for self-localization of the ego-vehicle, selecting the dataset comprises determining a subset of the datasets of the digital representation of the trajectory, wherein for each dataset of the subset, the respective altitude of the capturing vehicle matches the altitude of the ego-vehicle within a predefined tolerance range. One of the datasets is selected from the subset of the datasets depending on the at least one further feature descriptor.

In other words, in a first step, the available datasets of the digital representation are filtered according to the respective altitude of the capturing vehicle they store. Only such datasets, which contain an altitude of the capturing vehicle, which is equal to the determined altitude of the ego-vehicle up to the predefined tolerance range, are used for the attempt to match the at least one further feature descriptor in a second step. In this way, the risk for false positive matching of the feature descriptors is reduced.

According to a further aspect of the invention, a method for guiding an ego-vehicle at least in part automatically is provided. Therein, for each of a plurality of reference trajectories, a digital representation of the reference trajectory is generated or updated by using a method according to the invention. A further camera image of an environment of the ego-vehicle is captured by a camera of the ego-vehicle, in particular while the ego-vehicle is located in the predefined spatial region. At least one further feature descriptor of the further camera image is determined, in particular by at least one computing unit of the ego-vehicle, and an altitude of the ego-vehicle is determined. One of the plurality of reference trajectories is selected, in particular by the at least one computing unit of the ego-vehicle, depending on the determined altitude of the ego-vehicle and depending on the at least one further feature descriptor. The ego-vehicle is guided at least in part automatically along the selected reference trajectory.

For example, the at least one computing unit may generate control signals for guiding the ego-vehicle along the selected reference trajectory and provide the control signals to respective actuators of the ego-vehicle, which affect the lateral and/or longitudinal control of the ego-vehicle to guide it along the selected reference trajectory.

For example, the ego-vehicle may be parked into a parking space or parking slot by guiding the ego-vehicle at least in part automatically along the selected reference trajectory.

According to several implementations of the method for guiding the ego-vehicle at least in part automatically, selecting the reference trajectory comprises determining a subset of the plurality of reference trajectories, wherein for each reference trajectory of the subset the altitude of the capturing vehicle according at least one of the datasets of the respective digital representation matches the altitude of the ego-vehicle within a predefined tolerance range. One of the subsets of reference trajectories is then selected depending on the at least one further feature descriptor.

In particular, as described above for the method for self-localization, in a first step, the plurality of reference trajectories is filtered according to the altitude of the ego-vehicle, and in a second step, one of the remaining reference trajectories of the subset is selected by matching the at least one further feature descriptor with the respective feature descriptors of the reference trajectories of the subset.

According to a further aspect of the invention, a system for generating or updating a digital representation of a trajectory in a predefined spatial region is provided. The system is adapted to carry out a method for generating or updating a digital representation of a trajectory according to the invention. To this end, the system may, in particular, comprise the camera for the capturing vehicle, the at least one computing unit for the capturing vehicle and respective means for determining the altitude of the capturing vehicle.

According to a further aspect of the invention, a system for self-localization of an ego-vehicle is provided. The system is adapted to carry out a method for self-localization of an ego-vehicle according to the invention. To this end, the system may, in particular, comprise a camera for ego-vehicle, the at least one computing unit for the ego-vehicle and the respective means for determining the altitude of the ego-vehicle.

According to a further aspect of the invention, an electronic vehicle guidance system for an ego-vehicle is provided. The electronic vehicle guidance system is adapted to carry out a method for guiding the ego-vehicle at least in part automatically according to the invention. To this end, the system may, in particular, comprise a camera for ego-vehicle, the at least one computing unit for the ego-vehicle and the respective means for determining the altitude of the ego-vehicle.

An electronic vehicle guidance system may be understood as an electronic system, configured to guide a vehicle in a fully automated or a fully autonomous manner and, in particular, without a manual intervention or control by a driver or user of the vehicle being necessary. The vehicle carries out all required functions, such as steering maneuvers, deceleration maneuvers and/or acceleration maneuvers as well as monitoring and recording the road traffic and corresponding reactions automatically. In particular, the electronic vehicle guidance system may implement a fully automatic or fully autonomous driving mode according to level 5 of the SAE J3016 classification. An electronic vehicle guidance system may also be implemented as an advanced driver assistance system, ADAS, assisting a driver for partially automatic or partially autonomous driving. In particular, the electronic vehicle guidance system may implement a partly automatic or partly autonomous driving mode according to levels 1 to 4 of the SAE J3016 classification. Here and in the following, SAE J3016 refers to the respective standard dated June 2018.

Guiding the vehicle at least in part automatically may therefore comprise guiding the vehicle according to a fully automatic or fully autonomous driving mode according to level 5 of the SAE J3016 classification. Guiding the vehicle at least in part automatically may also comprise guiding the vehicle according to a partly automatic or partly autonomous driving mode according to levels 1 to 4 of the SAE J3016 classification.

According to a further aspect of the invention, a first computer program comprising first instructions is provided. When the first instructions are executed by a system for generating or updating a digital representation of a trajectory according to the invention, the first instructions cause the system to carry out a method for generating or updating a digital representation of a trajectory according to the invention.

According to a further aspect of the invention, a second computer program comprising second instructions is provided. When the second instructions are executed by a system for self-localization of an ego-vehicle according to the invention, the second instructions cause the system to carry out a method for self-localization of an ego-vehicle according to the invention.

According to a further aspect of the invention, a third computer program comprising third instructions is provided. When the third instructions are executed by an electronic vehicle guidance system according to the invention, the third instructions cause the electronic vehicle guidance system to carry out a method for guiding an ego-vehicle at least in part automatically according to the invention.

According to a further aspect of the invention, a computer-readable storage medium is provided, which stores a first computer program according to the invention, a second computer program according to the invention and/or a third computer program according to the invention.

The computer programs according to the invention and the computer-readable storage medium according to the invention may be denoted as respective computer program products comprising the first, second and/or third instructions, respectively.

The first, second and/or third instructions may be provided as program code. The program code can be provided as binary code or assembler and/or as source code of a programming language, for example C, and/or as program script, for example Python.

In the figures:

FIG. 1 shows schematically a vehicle with an exemplary implementation of an electronic vehicle guidance system according to the invention;

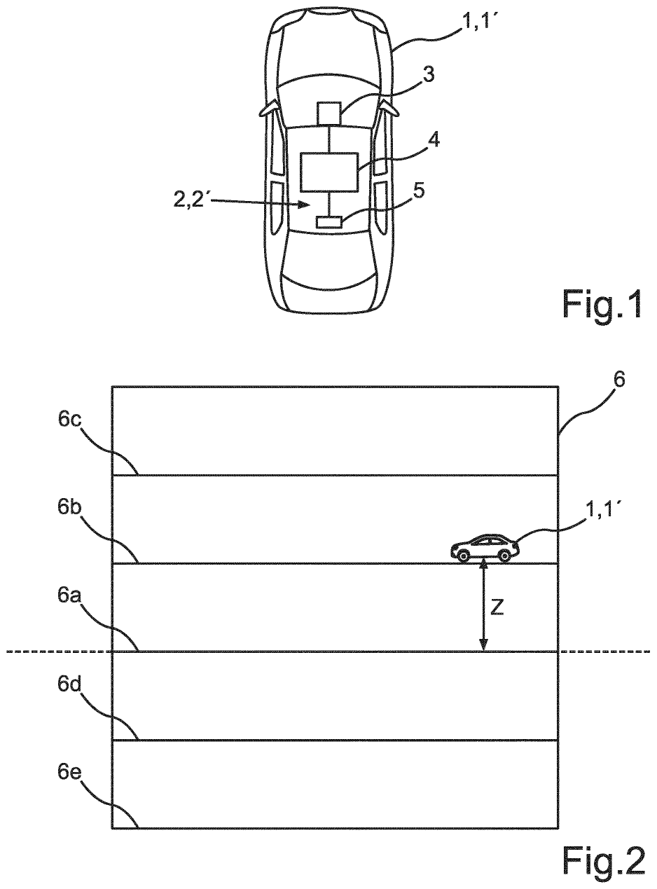

FIG. 2 shows schematically a multi-level parking facility; and

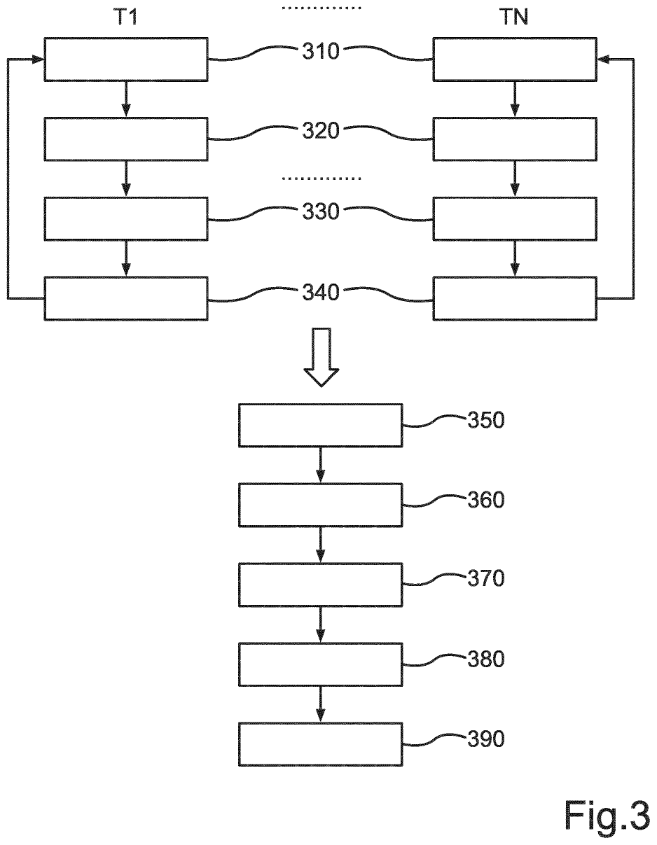

FIG. 3 shows a schematic flow diagram of an exemplary implementation of a method for guiding an ego-vehicle at least in part automatically according to the invention.

FIG. 1 shows schematically an ego-vehicle 1, which contains an exemplary implementation of an electronic vehicle guidance system 2 according to the invention. The electronic vehicle guidance system 2 is adapted to carry out a method according to the invention for guiding the ego-vehicle 1 at least in part automatically according to the invention. The ego-vehicle 1 may be identical to a capturing vehicle 1′. In this case, the electronic vehicle guidance system 2 is also adapted to carry out a method for generating or updating a digital representation or trajectory according to the invention. The ego-vehicle 1 may also be different from the capturing vehicle 1′. In this case, the capturing vehicle 1′ comprises a system 2′ for generating or updating a digital representation of a trajectory according to the invention. In the following it is assumed that the capturing vehicle 1′ is identical to the ego-vehicle 1, if not stated otherwise. In particular, the ego vehicle 1 acts as the capturing vehicle 1′ as well. The explanations carry over analogously to the opposite case as will be apparent for the skilled reader.

The electronic vehicle guidance system 2 comprises at least one computing unit, which is in FIG. 1 represented by a single computing unit 4, and a camera 3, for example a front camera. Optionally, the electronic vehicle guidance system 2 may comprise a GNSS receiver, which is, in particular, adapted to operate according to a dGNSS technique.

FIG. 2 shows the ego-vehicle 1 or the capturing vehicle 1′, respectively, in a multi-level parking facility 6. In the non-limiting example of FIG. 2, the parking facility 6 has one ground level floor 6a, two floors 6b, 6c above ground level and two floors 6d, 6e below ground level. An altitude z of the ego-vehicle 1 or capturing vehicle 1′ may, without loss of generality, be defined with respect to the ground level floor 6a.

FIG. 3 shows a flow diagram of an exemplary implementation of a method for guiding the ego-vehicle 1 at least in part automatically according to the invention. Therein, in steps 310 to 340, a method for generating or updating a digital representation of a trajectory is carried out for each of a plurality of reference trajectories T1, TN. To this end, the capturing vehicle 1′ is driven in the respective predefined spatial region, for example, the parking facility 6, along the respective reference trajectory T1, TN. The steps 310 to 340 are repeated several times for a plurality of time instances. For each of the plurality of time instances, the camera 3 of the capturing vehicle 1′ captures an image of the environment of the capturing vehicle 1′ in step 310. The computing unit 4 of the capturing vehicle 1′ determines at least one feature descriptor of the respective camera image and determines a two-dimensional pose of the capturing vehicle 1′ in a predefined coordinate system depending on the camera image in step 320, in particular using VSLAM. The altitude z of the capturing vehicle 1′ is determined in step 330. To this end, the computing unit 4 of the capturing vehicle 1′ may, for example, apply a visual odometry method to captured images and/or further captured images or may use the respective satellite signals and correction signals received by the optional dGNSS receiver 5 to determine the altitude z.

The computing unit 4 of the capturing vehicle 1′ generates or updates a respective dataset of the digital representation of the respective reference trajectory T1, TN in step 340. The dataset comprises the respective at least one feature descriptor, the respective pose of the capturing vehicle 1′ and the respective altitude z of the capturing vehicle 1′.

From step 350 onwards, the capturing vehicle 1′ is now denoted as ego-vehicle 1. In alternative implementations where the capturing vehicle 1′ is not the same vehicle as the ego-vehicle 1, the generated or updated representations of the reference trajectories T1, TN are transferred to the computing unit 4 of ego-vehicle 1.

In step 350, the ego-vehicle 1 is located in the spatial environment, for example, the parking facility 6, and the camera 3 of the ego-vehicle 1 captures a further camera image of the ego-vehicle's 1 environment. In step 360, the computing unit 4 of the ego-vehicle 1 determines at least one further feature descriptor of the further camera image and a two-dimensional pose of the ego-vehicle 1 using VSLAM. In step 370, the altitude z of the ego-vehicle 1 is determined, for example by means of visual odometry or using dGNSS.

In step 380, the reference trajectories T1, TN are filtered according to the determined altitude z of the ego-vehicle 1. Therein, all reference trajectories T1, TN, which do not contain any dataset corresponding to a key-frame, wherein the altitude z of the capturing vehicle 1′ was equal to the altitude z of the ego-vehicle 1 up to a predefined tolerance range, are disregarded. The computing unit 4 tries to match the at least one further feature descriptor with the respective at least one feature descriptor of the datasets of the remaining reference trajectories T1, TN. In case a match is found, the corresponding trajectory is selected. If more than one trajectory is found to match, one of them is selected according to a predefined rule, for example, based on a user input or randomly or based on historic behavior of the ego-vehicle 1 or a user of the ego-vehicle 1.

The ego-vehicle 1 is then guided at least in part automatically along the selected reference trajectory T1, TN, for example, to a parking space in the parking facility 6 in step 390.

For example in multi-level parking facilities, it may be difficult for a VSLAM algorithm to precisely recognize the vehicle's position considering each floor of the multi-level parking facility may look much the same except for some specific markings/details. In such a situation, the features obtained from a camera image captured on one floor may potentially match the respective features on other floors. features obtained from other parking floors. Hence, the performance of the VSLAM algorithm may be reduced.

According to several implementations of the invention, altitude measurements are recorded along with two-dimensional poses and feature descriptors. Similar looking scenes around the vehicle in multiple parking floor levels yield similar data which are potentially hard to distinguish. The altitude information of each key-frame therefore helps to identify the most relevant key-frames, thus eliminating false positive key-frames recorded in a different parking floor. The altitude may be measured relatively with respect to the ground. This measurement can be achieved using different ways, for example using visual odometry or dGNSS.

This approach allows for a very reliable filtering and matching feature points with valid key-frames only. Based on the current position of the ego-vehicle, the key-frames can be filtered using the altitude information, and the matching between the current frame key-points to these filtered frames provides a more reliable re-localization.

1. A method for generating or updating a digital representation of a trajectory in a predefined spatial region, wherein for each of a plurality of time instances while driving a capturing vehicle along the trajectory, the method comprises:
a camera image of an environment of the capturing vehicle;
determining at least one feature descriptor of the camera image; determining a two-dimensional pose of the capturing vehicle in a coordinate system of the digital representation depending on the camera image;
determining an altitude of the capturing vehicle; and
generating or updating a dataset of the digital representation, which comprises the at least one feature descriptor, the two-dimensional pose of the capturing vehicle, and the altitude of the capturing vehicle.

2. The method according to claim 1,
wherein motion data of the capturing vehicle is determined while the capturing vehicle is driven along the trajectory; and
the two-dimensional pose is determined depending on the motion data using odometry.

3. The method according to claim 1 wherein an algorithm for visual simultaneous localization and mapping is used for determining the two-dimensional pose of the capturing vehicle depending on the camera image.

4. The method according to claim 1, wherein the altitude is determined using visual odometry based on the camera images captured for the plurality of time instances and/or based on further camera images captured by the camera while the capturing vehicle is driven along the trajectory.

5. The method according to claim 1, wherein the altitude is determined using a differential global navigation satellite system.

6. The method according to claim 1, wherein the predefined spatial region is a part of a multi-level parking facility.

7. A method for self-localization of an ego-vehicle, comprising:
generating or updating a digital representation of a trajectory according to claim 1;
capturing, by a camera of the ego-vehicle, a further camera image of an environment of the ego-vehicle;
determining at least one further feature descriptor of the further camera image and an altitude of the ego-vehicle;
selecting one of the datasets of the digital representation depending on the determined altitude of the ego-vehicle and the at least one further feature descriptor; and
determining a two-dimensional pose of the ego-vehicle in the coordinate system of the digital representation from the selected dataset.

8. The method according to claim 7, wherein selecting the dataset comprises:
determining a subset of the datasets of the digital representation, wherein for each dataset of the subset the altitude of the capturing vehicle matches the altitude of the ego-vehicle within a predefined tolerance range; and
selecting one of the datasets from the subset of the datasets depending on the at least one further feature descriptor.

9. A method for guiding an ego-vehicle at least in part automatically, wherein:
for each of a plurality of reference trajectories, a digital representation of the reference trajectory is generated or updated by using a method according to claim 1;
a further camera image of an environment of the ego-vehicle is captured by a camera of the ego-vehicle;
determining at least one further feature descriptor of the further camera image and an altitude of the ego-vehicle;
selecting one of the plurality of reference trajectories depending on the determined altitude of the ego-vehicle and the at least one further feature descriptor; and
guiding the ego-vehicle, at least in part automatically, along the selected reference trajectory.

10. The method according to claim 9, wherein selecting the reference trajectory comprises:
determining a subset of the plurality of reference trajectories, wherein for each reference trajectory of the subset the altitude of the capturing vehicle according to at least one of the datasets of the digital representation matches the altitude of the ego-vehicle within a predefined tolerance range; and
selecting one of the subset of reference trajectories depending on the at least one further feature descriptor.

11. The method according to claim 9,
wherein the ego-vehicle is parked into a parking space by guiding the ego-vehicle at least in part automatically along the selected reference trajectory.

12. A system for generating or updating a digital representation of a trajectory in a predefined spatial region, wherein the system is adapted to carry out a method according to claim 1.

13. A system for self-localization of an ego-vehicle, wherein the system is adapted to carry out a method according to claim 7.

14. An electronic vehicle guidance system, which is adapted to carry out a method according to claim 9.

15. A non-transitory computer program product, comprising:
instructions which, when executed by a system for generating or updating a digital representation of a trajectory in a predefined spatial region, cause the system to carry out a method according to claim 1.
